(19) United States
(12) Patent Application Publication
(10) Pub. No.: US 2010/0321196 A1
(43) Pub. Date: Dec. 23, 2010

(54) Portable Belt Clip with Locator System

(75) Inventor: Wei-Cheng Cheng, Taipei County (TW)

Correspondence Address: SCHMEISER OLSEN & WATTS, 18 E UNIVERSITY DRIVE, SUITE # 101, MESA, AZ, 85201, US

(73) Assignee: LUCENT TRANS INC., Chino Hills, CA (US)

(21) Appl. No.: 12/489,268

(22) Filed: Jun. 22, 2009

(51) Int. Cl. G08B 21/00

(52) U.S. Cl. 340/686.6

(57) ABSTRACT

A portable belt clip with locator system for locating and tracking whereabouts of a subject such as stray child includes a belt clip transmitter further including: a charging unit; a radio frequency (RF) transmitter for transmitting RF signal; a memory module; a transmitting embedded system connecting with said charging unit, said memory module and said radio frequency (RF) transmitter; and a belt clip external receiver further including: a liquid crystal display (LCD) panel for displaying position information of the subject; a charging unit; a radio frequency (RF) receiver for receiving RF signal; a memory module; a receiving embedded system connecting with said charging unit, said memory module, liquid crystal display (LCD) panel and said radio frequency (RF) receiver.

### BACKGROUND OF THE INVENTION

1. Field of the Invention

The present invention relates to cell phone belt clip apparatus and more specifically to belt clips includes a radio frequency transmitter or receiver wherein the entire receiver and locator system can house in a cell phone belt clip whereas transmitter is housed in a separated belt clip.

2. Description of the Prior Art

With the rise in popularity of cellular telephones and personal electronic devices, such as personal digital assistants, MP3 players, and small computers or communicators, portable devices users find portable devices cradles to be indispensable. In the fast-paced twenty-first century, users need to access their portable devices quickly. Portable devices cradles that can be conveniently clipped onto a user's belt or clothing provide an easy access to the portable devices and lessen the likelihood that the user leaves their phone at home, misplaces or loses their portable devices.

Portable belt clip devices are commonly used to allow a user to carry a communication device without hand-carrying such devices or carrying them in a pocket, bag, purse or briefcase, where it may be difficult to hear a ring from the communication device, and where the device may potentially be damaged or not readily accessible for use. A belt clip device generally has a base or holder for releasable attachment to the communication device or other portable device, and a clip hinged to the base and spring loaded towards the base for engagement over a wearer's belt or the like in order to attach the device to the belt. In some cases, the base is of a holster type for receiving a major portion of the communication device. In other cases, the base and housing of the communication device have latching formations to allow the communication device to be released securely from the base.

Along with the increase in usage, portable devices belt clip has come the requests for improved functionality. Consumers are now looking for more than just belt clip. Meanwhile, manufacturers struggle to meet consumer demands for more options and more functionality.

Due to the decrease in size and weight of personal electronic devices, such as cellular phone, personal digital assistants, MP3 players, and small computers or communicators, extra space is available for install device in the these belt clips to add special functions to the belt clip.

### SUMMARY OF THE INVENTION

It is perhaps the greatest fear of a parent to lose a child. With shopping malls, amusement parks, arcades and similar places which attract a crowd available to almost every community, the opportunity presents itself for a child to become lost. Getting lost or separated is every child's dread and every parent's overwhelming fear especially in a crowd or near traffic yet each conventional approach is inadequate in ensuring the safety of the child. Holding hands with or carrying the child are insufficient in many ways; it is both strenuous and often impossible to maintain holding hands in that it goes against the child's natural tendency for independent walking. It is uncomfortable for both adult and child due to the disparity in height between adult and child, and is impossible to maintain with a squirming child. Constantly trying to maintain contact ruins fun of the activity and, in a shopping situation, is impractical since it prevents the use of one hand for both adult and child and a breach of safety occurs often whenever the hands are let go. Carrying the child is too cumbersome for the parent and too uncomfortable for the child to be maintained for any length of time and inherits the same disadvantages of holding hands. An even worse scenario, which may occur, is a kidnapping. It is extremely desirable to prevent these problems from occurring in the first place. In the event of such an occurrence, it is also desirable to solve the problems associated therewith as efficiently as possible.

One objective of this invention is the locator system that can be clip on the subject that is being tracked and paired up receiver to locate whereabouts of the subject.

The present invention is to provide a portable belt clip with locator system which integrates RF receiver with portable belt clip and uses portable belt clip to provide power to the portable device.

The present invention also overcomes the foregoing and other problems with a portable device belt holder enabling longer standby and talk times without increasing the size of a hand-held cellular telephone unit. The belt clip includes a housing defining a cradle for receiving a cellular telephone unit. A battery is incorporated within the housing such that the housing and battery can be clipped to the belt of a user. The battery may be permanently integrated within the housing or removable such that once the battery has discharged it may be removed and a new battery inserted within the housing. If the battery is integrated with the housing a means for recharging the battery may be included.

By integrating RF transmitter with a belt clip that contains rechargeable battery, power can be drawn from the battery to support the operation of locator system and charge the portable device as well.

Another object of the present invention is to provide a RF receiver which takes in the RF signals and PIN code from the transmitter to locate and display the position of the transmitter by displaying the information on the liquid crystal display (LCD). Other communication device can also be charged at same time by connecting power connector of the belt clip.

To achieve the above objects, the present invention provides a belt clip transmitter, which uses a transmitting embedded system to control radio frequency (RF) transmitter for transmitting RF signal. A belt clip external receiver uses a receiving embedded system to calculate the position of the subject. This invention may be embodied in the form illustrated in the accompanying drawings, attention being called to the fact, however, that the drawings are illustrative only and changes may be made in the specific construction illustrated and described within the scope of the appended claims.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of portable belt clip with locator system which includes a belt clip transmitter and a belt clip external receiver;

FIG. 2 is a perspective view from child's view with belt clip transmitter clipped on the child;

FIG. 2a is a block diagram illustrating the components of the belt clip transmitter 1 for transmitting RF signal along with PIN code;

FIG. 2b is a programming flow diagram illustrating the programming of said transmitting embedded system;

FIG. 3 is a perspective view from parent's view point holding a belt clip external receiver;

FIG. 3a is block diagram illustrating the components of the belt clip external receiver;

FIG. 3b is a programming flow diagram illustrating the programming of receiving embedded system;

### DETAILED DESCRIPTION OF THE PREFERRED EMBODIMENT

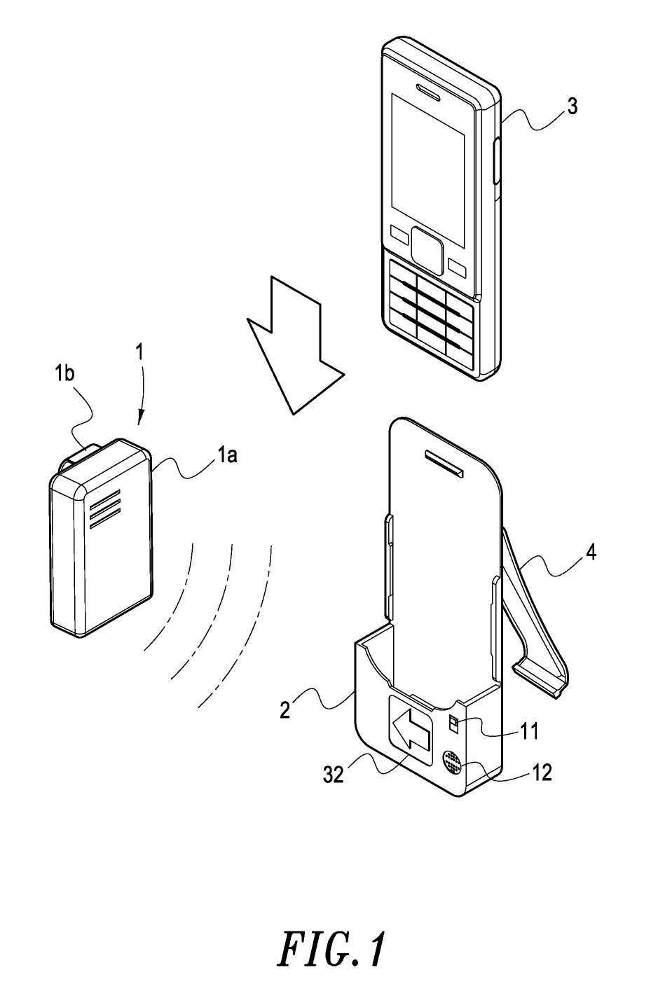

A portable belt clip with locator system is illustrated in FIG. 1 sending radio frequency (RF) signal and personal identification number (PIN) from a belt clip transmitter 1 to belt clip external receiver 2. The belt clip transmitter 1 comprises a housing 1a and a belt clip 1b. The housing 1a and a belt clip 1b are preferably constructed from a rigid plastic material, like ABS, polycarbonate, or equivalent, and are preferably manufactured by way of an injection molding process. The belt clip 1b preferably comprises at least a clip type structure for clipping on the subject's clothing to track about subject's whereabouts. External device 3 such as cell phones, iPod, and PDA or GPS system can be fixed onto the belt clip external receiver 2. Also the charging unit of the belt clip external receiver 2 can be connected to external device 3 for additional power to external device 3. Device such as speaker 12 and switch 11 can be installed on the belt clip external receiver 2 for turning on and off the belt clip external receiver 2 or sending out alert sound to alert the user.

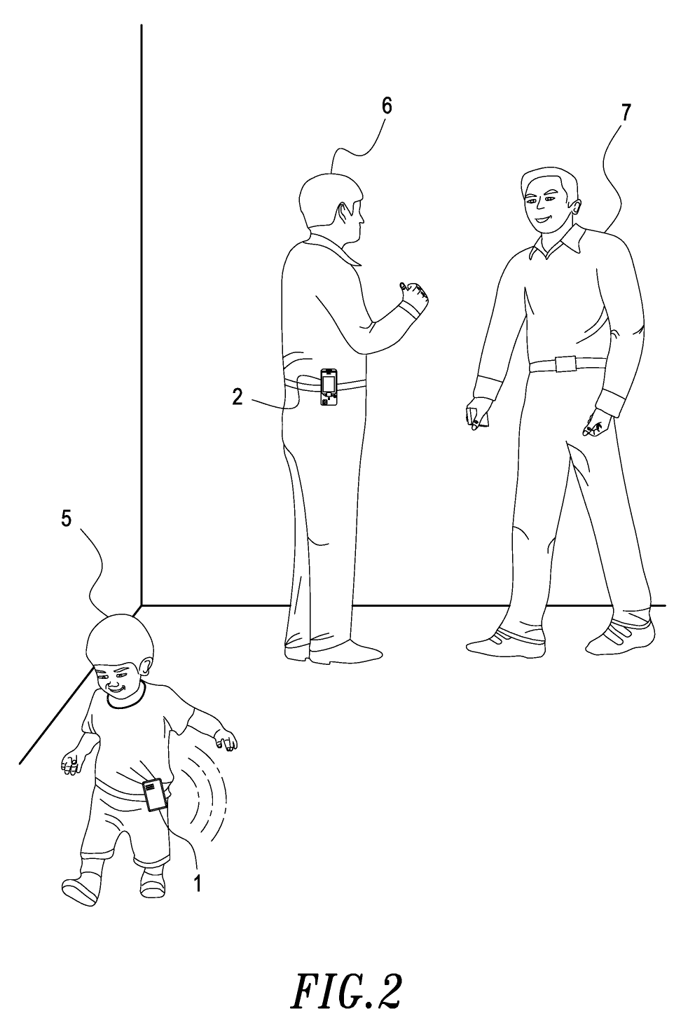

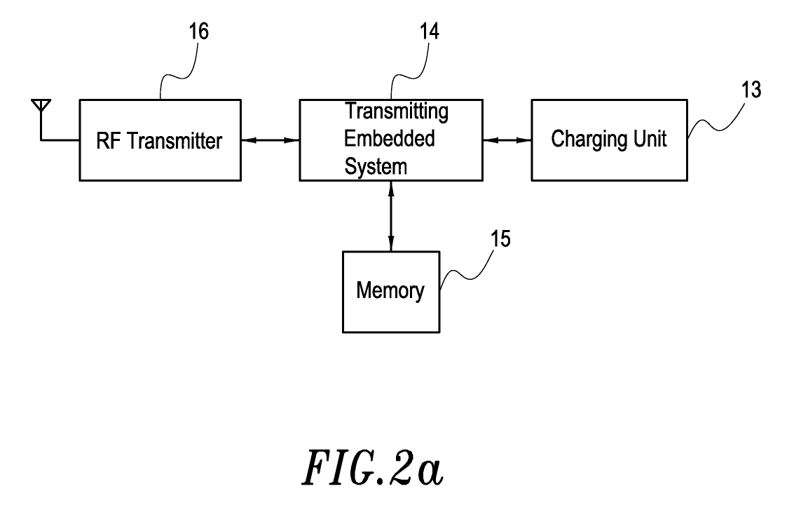

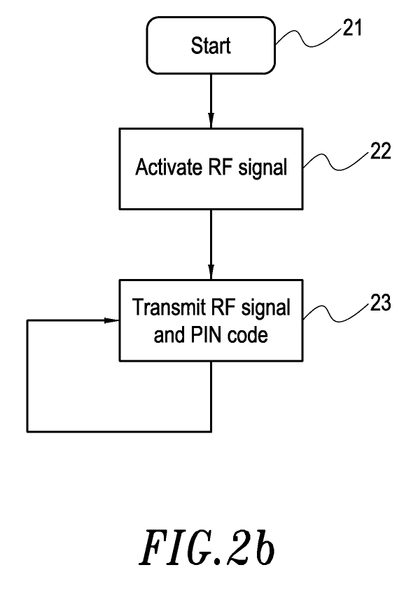

Thus, as shown in FIG. 2, belt clip transmitter 1 can be clipped on subject such as a running away child 5. The belt clip transmitter 1 can send radio frequency (RF) signal and personal identification number (PIN) to said belt clip external receiver 2 which in turn is held by the parents such as a parent 6 who is engaging a conversation with other individual 7. A personal identification number (PIN) is a secret numeric password shared between the belt clip transmitter 1 and belt clip external receiver 2 that can be used to authenticate belt clip transmitter 1 to belt clip external receiver 2. Typically, the belt clip external receiver 2 is required to provide a non-confidential user identifier or token and a confidential PIN to gain access to the information that is transmitted by belt clip transmitter 1. Upon receiving the User ID and PIN, the system looks up the PIN based upon the User ID and compares the looked-up PIN with the received PIN. The belt clip external receiver 2 is granted access only when the number entered matches with the number stored in the belt clip transmitter 1.

A block diagram illustrating the components of the belt clip transmitter 1 for transmitting RF signal along with PIN code is provided in FIG. 2a. As can be seen from this figure, the belt clip transmitter 1 includes a charging unit 13 for providing power. The charging unit 13 furthermore connected to a transmitting embedded system 14. Also connected to the transmitting embedded system 14 are a radio frequency (RF) transmitter 16 for transmitting RF signal and a memory module 15. A transmitter of radio-frequency (RF) signals for wireless communication over some distance, which can vary from the short ranges within a building to long distances. The said radio frequency (RF) transmitter can utilize signals from very low frequencies (VLF) to extremely high frequencies (EHF). The radio-frequency output power varies from a fraction of a watt for short range distance to several megawatts in long-range, low-frequency transmitting. The transmitting embedded system 14 is utilized to control said radio frequency (RF) transmitter 16. The transmitting embedded system 14 is some combination of computer hardware and software, either fixed in capability or programmable, that is specifically designed for controlling the belt clip transmitter 1.

A programming flow diagram illustrating the programming of said transmitting embedded system is provided in FIG. 2b. As can be seen from this figure, the transmitting embedded system activates said radio frequency (RF) transmitter 22. Information and PIN which is stored in said memory module is encoded by said transmitting embedded system. The radio frequency (RF) transmitter transmits encoded information and PIN by radio frequency carrier wave and ready to be decoded by corresponding belt clip external receiver which is held by the driver 23.

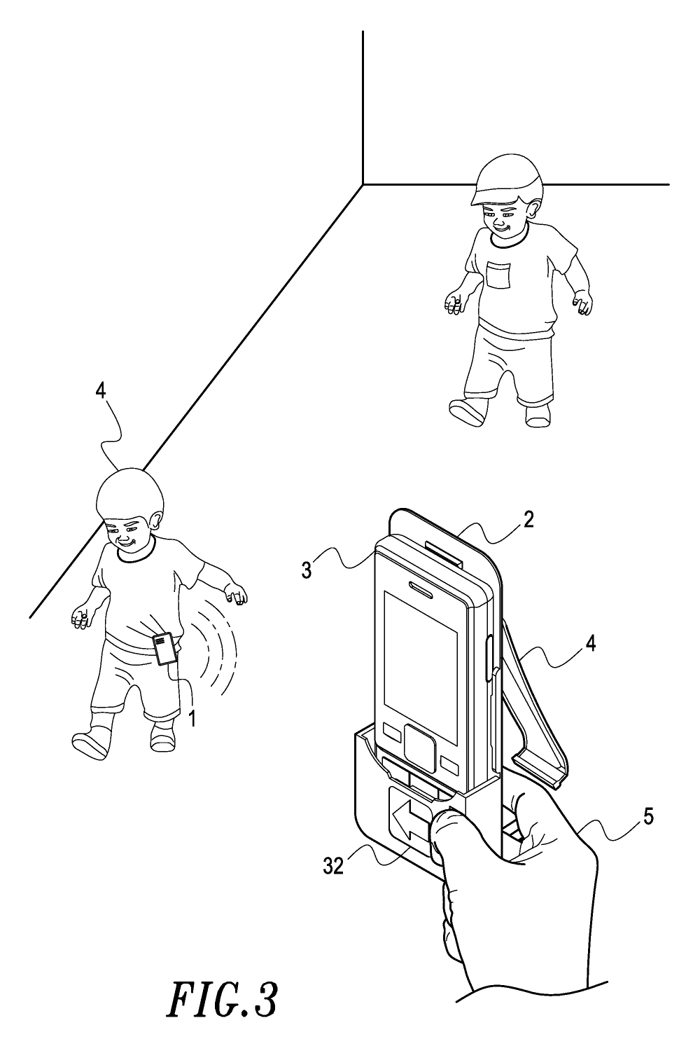

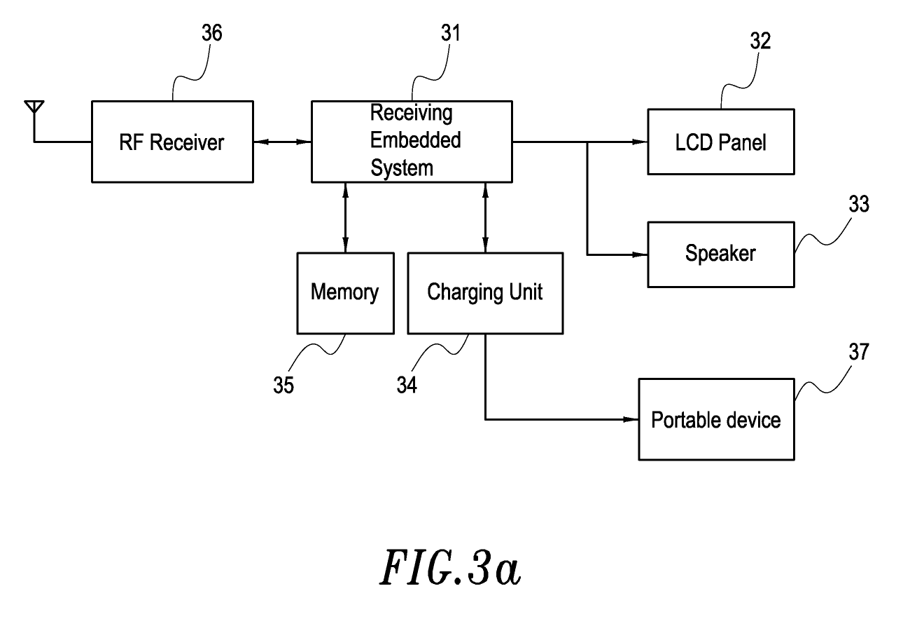

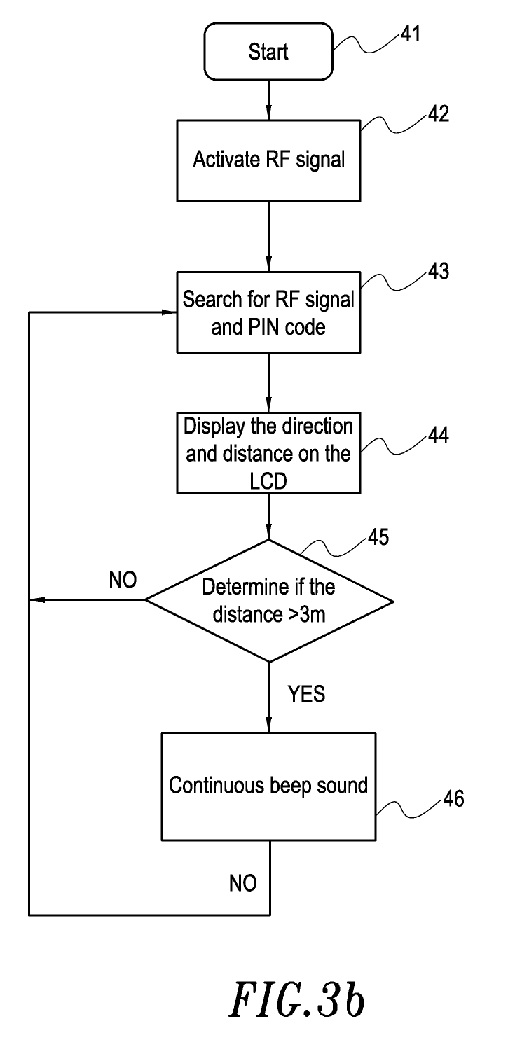

A perspective view from parent's view point is shown in FIG. 3. This view shows the parent trying to find where his child 4 is. The parent 5 is holding said belt clip external receiver 2 which receives encoded information and PIN from the belt clip transmitter clipped on the child via radio frequency (RF) wave. The belt clip external receiver 2 includes liquid crystal display 32 showing the direction and distance of the child related to the parent.

A block diagram illustrating the components of the belt clip external receiver is provided in FIG. 3a. It is noted from the figure, the belt clip external receiver includes a receiving embedded system 31 for controlling operation of the belt clip external receiver. The receiving embedded system 31 is connected to said LCD panel 32 and speaker 33 to display or alarm distance and direction of the parent's child. The LCD 32 displays the direction and distance between the transmitter and the receiver. In this case, it shows the distance from the parent to the child and demonstrates the direction of the child. The speaker 33 gives alarm as soon as the distance exceeds a certain limit. Also connected to the receiving embedded system 31 are the charging unit 34, memory module 35 and radio frequency (RF) receiver 36. The charging unit 34 provides power to the receiving embedded system 31 as well as to the portable device 37 such as cellular phones, iPod, PDA or GPS. Connection can be made by connecting said charging unit 34 to portable device 37 such as cell phones, iPod, PDA or GPS for power charging.

The memory module 35 stores the corresponding user ID and compares the looked-up PIN for identifying the corrected signal from said belt clip transmitter. The radio frequency (RF) receiver takes in the Radio frequency (RF) signal and PIN code from the belt clip transmitter to locate the position of the subject by following four techniques.

Time of Arrival (TOA)
Time of arrival (TOA) is method for determining the distance relative to the belt clip transmitter and the belt clip external receiver. The radio frequency (RF) receiver gain patterns of a rotating antenna or measurement of the very small time difference between the arrival of a radio frequency wavefront from the transmitter at one antenna and its arrival at another antenna.

Time Difference of Arrival (TDOA)
With the time difference technique (generally referred to as phase interferometry) the two antennas are held at the observing location a fixed distance from each other. The bearing angle of the radio wavefront relative to the two antennas is related to the measured difference in time of arrival by an inverse sine function. The relative phase difference between two electrical signals developed by the radio wavefront in the two antennas is determined through measurement.

Angle of Arrival (AOA)
Angle of Arrival measurement or AOA is a method for determining the direction of propagation of a radio-frequency wave incident on an antenna array. AOA determines the direction by measuring the Time Difference of Arrival (TDOA) at individual elements of the array from these delays the AOA can be calculated. Its basic function is to measure the frequency of pulsed signals radiated from radio frequency (RF) transmitter. Generally, it may be said that radio frequency (RF) receiver measures the frequencies of incoming RF signals utilizing interferometric techniques by detecting the phase shift magnitudes produced in multiple, calibrated delay lines. For instance, the received RF signal is divided and simultaneously introduced into a non-delayed path and a delay line of known length. Since the delayed and non-delayed receiver paths are functions of the input signal frequency, conversion of the phase difference signals to video signals provides signals whose amplitudes are related to phase delay. These signals typically take the form of sin function which makes amplitude comparisons of the signals, determines the numerical value of .omega., and generates the digital frequency descriptive word.

Received Signal Strength (RSS)
Received signal strength (RSS) utilizes trilateration to signal strength measurements obtained from signals received from at least three stationary position nodes. Since the received signal strength is based on the environment model, models may play an important role in the received signal strength. Models of the wireless environment provide information based on signal strength, channel assignments, and access point geographic locations.

By using the above techniques, the receiving embedded system is able to calculate the distance and display the direction on the LCD based on the RF signal sent from the belt clip transmitter.

A programming flow diagram illustrating the programming of said receiving embedded system is provided in FIG. 3b. At the step 42, the receiving embedded system activates the radio frequency (RF) receiver 42 and at step 44 said receiving embedded system searches for RF signal and PIN code that matches the one stored in memory module. After finding the corresponding RF signal and PIN code, the receiving embedded system will display distance and direction information on the LCD. The receiving embedded system gives a beep with its speaker when it detects the signals from the transmitter. At step 45, the system determines whether the distance between the receiver and the transmitter is more than 3 meters. If the distance is more than 3 meters, the receiving embedded system will command speaker to give continuous beeps as shown in step 46. If the distance is less than 3 meters, the receiving embedded system will repeat distance checking process.

In the above detailed description, reference is made to the accompanying drawings which form a part hereof and in which is shown by way of illustration specific embodiments in which the invention can be practiced. These embodiments are described in sufficient detail to enable those skilled in the art to practice and use the invention, and it is to be understood that other embodiments may be utilized and that electrical, logical, or structural changes may be made without departing from the spirit and scope of the present invention. The following detailed description is, therefore, not to be taken in a limiting sense and the scope of the present invention is defined by the appended claims and their equivalents.

What is claimed is:

1. A portable belt clip with locator system, comprising:
a) a belt clip transmitter including:
i) a charging unit;
ii) a radio frequency (RF) transmitter for transmitting RF signal;
iii) a memory module;
iv) a transmitting embedded system connecting with said charging unit, said memory module and said radio frequency (RF) transmitter; and
b) a belt clip external receiver including:
i) a liquid crystal display (LCD) panel for displaying position information and distance of the transmitter;
ii) a charging unit;
iii) a radio frequency (RF) receiver for receiving RF signal;
iv) a memory module;
v) a receiving embedded system connecting with said charging unit, said memory module, liquid crystal display (LCD) panel and said radio frequency (RF) receiver.

2. The portable belt clip with locator system of claim 1 wherein said belt clip external receiver include a speaker which connected to said receiving embedded system.

3. The portable belt clip with locator system of claim 1 wherein said receiver embedded system calculated angle of arrival of the RF signal to find the location of the transmitter.

4. The portable belt clip with locator system of claim 1 wherein said receiver embedded system calculated time of arrival of the RF signal to find the location of the transmitter.

5. The portable belt clip with locator system of claim 1 wherein said receiver embedded system calculated time difference of arrival of the RF signal to find the location of the transmitter.

6. The portable belt clip with locator system of claim 1 wherein said receiving embedded system calculated received signal strength of the RF signal to find the location of the transmitter.

7. The portable belt clip with locator system of claim 1 wherein said transmitting embedded system encodes a personal identification number (PIN) code to transmit Radio Frequency (RF) signal though Radio Frequency (RF) transmitter.

8. The portable belt clip with locator system of claim 1 wherein said charging unit of belt clip external receiver provides power to portable device.
